(19) United States
(12) Patent Application Publication
(10) Pub. No.: US 2013/0005863 A1
(43) Pub. Date: Jan. 3, 2013

(54) DISPERSING AGENT

(76) Inventors: Manfred Bichler, Engelsberg (DE); Silke Flakus, Ebersberg (DE); Christoph Hofheinz, Stephanskirchen (DE)

(21) Appl. No.: 13/518,133

(22) PCT Filed: Jan. 17, 2011
(86) PCT No.: PCT/EP2011/050509

§ 371 Date: Jun. 21, 2012

(30) Foreign Application Priority Data
Jan. 21, 2010 (EP) 10153091.1

(51) Int. Cl. C08L 33/06; C08L 43/02; C08L 33/24; B01D 1/18; C08K 3/34; C08K 3/22; C08K 3/30; C08L 41/00; C08K 3/20

(52) U.S. Cl. 524/5; 525/224; 525/212; 525/209; 525/223; 525/217; 525/218; 524/523; 159/48.1

(57) ABSTRACT

A preferably pulverulent dispersing agent comprising as the component having a dispersing action the combination of (a) at least one representative of polycarboxylate ethers with a weight content of from 0.1 to 20%, (b) at least one representative of polycarboxylate esters with a weight content of from 0 to 20% and (c) at least one representative of non-charged copolymers with a weight content of from 0.1 to 20%, which is accessible by co-spray drying the individual components and which is suitable for controlling the flowability of aqueous chemical construction suspensions is claimed. By the dispersing agents which form in situ according to the invention, a controllable subsequent dosing of dispersing agent can be achieved without an additional process step. Furthermore, by subsequent dosing with a flow agent, an increased dosing efficiency of a polymer can be achieved, the extent of the dispersing can be controlled in several stages and the duration of the processability of a fresh mortar can be prolonged especially at elevated temperatures by an increasing saponification.

The present invention provides a dispersing agent, a process for its preparation and the use thereof.

Polycarboxylates, in particular in the form of polycarboxylate ethers, are very widely employed alongside polyacrylates, lignin-sulphonates, melamine-sulphonates and naphthalene-sulphonates—as dispersing agents (flow agents) for chemical construction preparations in order to reduce the water requirement of an otherwise identical composition or in order to improve the processability of an otherwise identical composition.

All the dispersing agents mentioned are polyelectrolytes which, due to their charge carrier in the polymer, are adsorbed onto the surfaces of the hydrating inorganic binders (e.g. cement, but also gypsum and anhydrite) and as a result modify the surface charge of the mineral particles (electrostatic dispersing mechanism). Comb polymers (polycarboxylate ethers) comprise a main chain (“backbone”), along which the functional groups capable of adsorption—as a rule carboxylates—are arranged, and—in contrast to the other dispersing agents mentioned—side chains which are built up, for example, from non-charged hydrophilic ethylene oxide units. These side chains take up a large amount of space (sterically demanding) and therefore additionally influence the dispersing action (steric dispersing mechanism). The polymers are adsorbed via their anionic groups onto the positively charged regions of the binder particles, while the side chains project into the pore space filled with mixing water and in this way inhibit, by steric hindrance, agglomeration of the solid particles, which explains the dispersing action. Up to the so-called saturation dose, the dispersing action of the dispersing agents (e.g. measurable by slump) increases as the amount added or the amount of polyelectrolyte adsorbed increases.

In this context, it has also been found that polycarboxylate ethers in particular in some cases react very sensitively to changes in the mortar and concrete recipes, which has led to corresponding fine variations in the molecular structure and therefore also to the known large number of suitable dispersing agents. Via knowledge of the structure/effect relationship, diverse, tailor-made additives having a dispersing action have thus become possible.

Different compositions of the dispersing agents result in different effects on the rheology of the building material mixtures and the hydration kinetics of the inorganic binders. The higher the charge density of the polymer, the higher the affinity for the surface of the solid and the greater the direct dispersing.

In addition to the chemical composition of the dispersing agent, the temperature and the chemical composition of the chemical construction preparation (in particular the rapidly water-soluble ions, such as e.g. alkali metal sulphates) inter alia also have an influence on the dispersing of the particles and, for example, on the processability of a fresh mortar.

At low temperatures and at a high concentration of ions which can be adsorbed onto surfaces of the solid in competition with the dispersion agent (e.g. sulphate ions), the charge density of the flow agent must be comparatively high in order for this to be completely active after a short time.

On the other hand, a high charge density of the flow agent at high temperatures and in chemical construction preparations with a low concentration of ions which can be adsorbed onto the binder surface in competition with the dispersing agent (e.g. sulphate ions) leads to the flow agent added rapidly losing effectiveness.

The duration of the influence on the rheology at a comparatively high charge density of the dispersing agent can be prolonged by increasing the total dose of the dispersing agent. Under certain circumstances (at dispersing agent concentrations significantly below the saturation dose), however, the initial slump is then also increased at the same time. On the other hand, post-liquefaction cannot be eliminated by increasing the dose of flow agent.

It is known that acrylic acid esters can be saponified in a basic medium. In this context, side chains are split off in part, and the steric component of the dispersing action is lost. It is therefore prior art to use instead methacrylic acid esters as dispersing agents, since these are significantly more stable towards saponification.

The use of polycarboxylate ethers as dispersing agents which show no splitting off of side chains in a basic medium is furthermore prior art.

A disadvantage of the dispersing agents and dispersing agent combinations known to date is that it is only very difficult to control the extent of the dispersing and also to improve further the duration of the processability of the mixed chemical construction compositions, such as are represented, for example, by fresh mortars.

This object has been achieved with a dispersing agent comprising as the component having a dispersing action the combination of

(a) at least one representative of polycarboxylate ethers with a weight content of from 0.1 to 20%,

(b) at least one representative of polycarboxylate esters with a weight content of from 0 to 20% and

(c) at least one representative of non-charged copolymers with a weight content of from 0.1 to 20%.

The use of the representatives mentioned as components (a), (b) and (c) as dispersing agents is very well known in particular from chemical construction uses. The individual representatives have also already been described in detail beforehand as prior art.

The polycarboxylate ethers provided as component (a) are to be found as copolymers, for example, in DE 10 2006 027 035 A1, U.S. Pat. No. 7,070,648 B1 and WO 2006/133933 A2. The content of WO 2006/133933 A2 is a substantial constituent of the present disclosure with respect to the copolymers described there.

With respect to the polycarboxylate ester variants (b) and possible embodiments thereof, reference is made in particular to EP 0 753 488 51, the content of which with respect to the dispersing agents described there is likewise a substantial constituent of the present disclosure.

The third component, namely representatives of variant (c), are to be found in the international patent application published as WO 2009/153202. The content thereof with respect to the dispersing agents described there is also a substantial constituent of the present disclosure.

It has been found, surprisingly, that now also polyacrylic acid derivatives, which indeed can have side chains but initially have no charge in aqueous solution of neutral pH and therefore also are not adsorbed onto charged surfaces in neutral solution, can now also be employed in dispersing agents in combination with other components having a dispersing action. Copolymers of vinyl ethers with hydroxypropyl acrylate (HPA) and/or hydroxyethyl acrylate (HEA) for example are also possible for this. If these copolymers are treated with bases, corresponding organic hydroxy compounds are split off and charge carriers (carboxylic acid groups) are formed.

The present invention also includes the use of non-charged components (c), such as e.g. polyacrylic acid derivatives, by themselves or in combination with conventional polycarboxylates and/or polycarboxylate ethers and/or other dispersing agents (such as melamine-sulphonates or naphthalene-sulphonates) for chemical construction preparations (e.g. ready-mixed dry mortar based on inorganic binders, such as e.g. Portland cement, Portland composite cement, alumina cement). However, dispersing of other solids in basic solution is also conceivable (e.g. alkaline-activated slag sand or anhydrites or pigments in alkaline solution).

By the dispersing agents which form in situ according to the invention, a controllable subsequent dosing of dispersing agents can now be achieved without an additional process step, which likewise was not foreseeable to this extent.

An advantage of the invention furthermore lies in the fact that the extent of dispersing can be controlled in several stages in this manner (e.g. with simultaneous use of HPA and HEA).

The duration of the processability of a fresh mortar can moreover be prolonged in this manner by an increasing saponification, especially at elevated temperatures.

Finally, by the dispersing agent combination according to the invention, it becomes possible to initially dose a flow agent outside the saturation dose and to compensate the loss of processability necessarily initiated by the low dose by the saponification of the initially non-charge component which starts. As a result, a long-lasting uniform processability is also achieved at an average level with a suitable flow agent formulation.

The large number of advantages of the present invention was thus not foreseeable,

Preferably, the dispersing agent according to the invention is in powder form, and in particular as a water-soluble powder. The water-soluble variant should be the rule.

In the context of this invention, a “water-soluble powder” here is understood as meaning a powder of which in general at least 0.01 wt. % dissolves in water at room temperature and which forms a clear one-phase solution without substantial clouding up to a concentration of 60 wt. % in water, preferably 40 wt. % in water. If clouding occurs in the water-soluble variant, this is usually due to the active compound or is to be attributed to the polymers.

The dispersing agent according to the present invention is characterized in particular in that it has been prepared by co-drying components (a), optionally (b) and (c), in particular using at least one representative of anticaking agents, pouring auxiliaries, stabilizing agents. Components (a), optionally (b) and (c) have preferably been subjected to a drying process, and preferably a spray drying, for this. The combinations of components (a+c) and/or (a+b+c) and/or (a+b) and/or (b c) are suitable in particular for this. The combination (a+c), which has been mixed subsequently with the separately dried component b, is particularly preferred. However, co-spray drying of components (a+b+c) is also to be regarded as very advantageous.

A detailed discussion of the individual suitable components (a), (b) and (c) of the dispersing agent according to the invention is given in the following:

Component (a):

The polycarboxylate ethers (a) should preferably be two representatives of a copolymer which differ from one another, in each case comprising

1) at least one olefinically unsaturated carboxylic acid derivative or an ester or a salt thereof and/or one olefinically unsaturated sulphonic acid derivative or a salt thereof,

and

2) at least one comonomer which, by the reaction of the polyether rnacromonomer, produces a structural unit in the copolymer which is represented by one of the general formulae (Ia), (Ib) and/or (Ic):

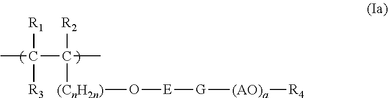

where

R¹, R² and R³ are in each case identical or different and independently of each other are represented by H and/or an unbranched or branched C₁-C₄ alkyl group;

E is identical or different and is represented by an unbranched or branched C₁-C₆ alkylene group, a cyclohexyl group, CH₂—C₆H₁₀, ortho-meta- or para-substituted C₅H₄ and/or a unit which is not present;

G is identical or different and is represented by O, NH and/or CO—NH, with the proviso that E is a unit which is not present, G is also in the form of a unit which is not present;

A is identical or different and is represented by CₓH₂ₓ, where x=2, 3, 4 and/or 5 (preferably x=2) and/or CH₂CH(C₆H₅);

n is identical or different and is represented by 0, 1, 2, 3, 4 and/or 5;

a is identical or different and is represented by an integer from 7 to 350 (preferably 10-200);

R⁴ is identical or different and is represented by H, an unbranched or branched C₁-C₂₀ alkyl group, a cycloaliphatic hydrocarbon radical having 5 to 8 C atoms, an optionally substituted aryl radical having 6 to 14 C atoms, CO—NH₂ and/or COCH₃;

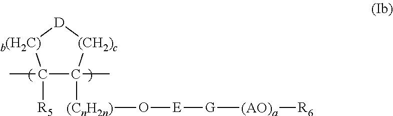

where

R⁵ is identical or different and is represented by H and/or an unbranched or branched C₁-C₄ alkyl group;

E is identical or different and is represented by an unbranched or branched C₁-C₆ alkylene group, a cyclohexyl group, CH₂—C₆H₁₀, ortho-meta- or para-substituted C₆H₄ and/or by a unit which is not present;

G is identical or different and is represented by a unit which is not present, O, NH and/or CO—NH, with the proviso that if E is a unit which is not present, G is also in the form of a unit which is not present;

A is identical or different and is represented by CₓH₂ₓ, where x=2, 3, 4 and/or 5 and/or CH₂CH(C₆H₅);

n is identical or different and is represented by 0, 1, 2, 3, 4 and/or 5;

a is identical or different and is represented by an integer from 7 to 350;

D is identical or different and is represented by a unit which is not present, NH and/or O, with the proviso that if D is a unit which is not present: b=0, 1, 2, 3 or 4 and c=0, 1, 2, 3 or 4, where b+c=3 or 4, and with the proviso that if D is NH and/or O: b=0, 1, 2 or 3, c=0, 1, 2 or 3, where b+c=2 or 3;

R⁶ is identical or different and is represented by H, an unbranched or branched C₁-C₂₀ alkyl group, a cycloaliphatic hydrocarbon radical having 5 to 8 C atoms, an optionally substituted aryl radical having 6 to 14 C atoms, CO—NH₂ and/or COCH₃;

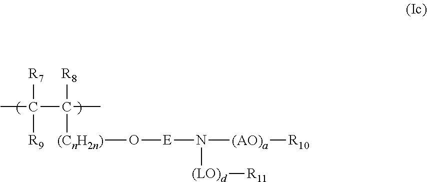

where

R⁷, R⁸ and R⁹ are in each case identical or different and independently of each other are represented by H and/or an unbranched or branched C₁-C₄ alkyl group;

E is identical or different and is represented by an unbranched or branched C₁-C₆ alkylene group, a cyclohexyl group, CH₂—C₆H₁₀, ortho-meta- or para-substituted C₆H₄ and/or by a unit which is not present;

A is identical or different and is represented by CₓH₂ₓ, where x=2, 3, 4 and/or 5 and/or CH₂CH(C₆H₅);

n is identical or different and is represented by 0, 1, 2, 3, 4 and/or 5;

L is identical or different and is represented by CₓH₂ₓ, where x=2, 3, 4 and/or 5 and/or CH₂. CH(C₆H₅);

a is identical or different and is represented by an integer from 7 to 350;

d is identical or different and is represented by an integer from 2 to 350;

R¹⁰ is identical or different and is represented by H and/or an unbranched or branched C₁-C₄ alkyl group;

R¹¹ is identical or different and is represented by H and/or an unbranched C₁-C₄ alkyl group.

In this connection, it is pointed out that 1.) in the copolymer of the polycarboxylate ether (a) the units which represent components 1) or 2) in each case have no differences within the molecule, and/or 2.) the copolymer a) is a polymeric mixture of components 1) and 2), wherein in this case the units have differences within the molecule with respect to the radicals R₁ and/or R₂ and/or R₃ and/or R₄ and/or R₅ and/or R₆ and/or R⁷ and/or R₈ and/or R₉ and/or R₁₀ and/or R₁₁ and/or n and/or a and/or b and/or c and/or d, and wherein the differences referred to relate in particular to the composition and length of the side chains,

With respect to the polycarboxylate ether (a) and its form shown, the disclosure of WO 2006/133933 A2 is an integral constituent of the present invention.

The present invention preferably provides a dispersing agent in which the copolymer (a) contains the comonomer component 1) in contents of from 50 to 99 mol % and the comonomer component 2) in contents of from 50 to 1 mmol %.

Representatives of type (a) which contain the comonomer component 1) in contents of from $0 to 90 mol % and the comonomer component 2) in contents of from 40 to 10 mol % are likewise to be regarded as preferred.

With respect to component (a), preferably, the comonomer component 1) should represent an acrylic acid or a salt thereof, and the comonomer component 2) should contain as the polyether rnacromonomer an alkoxylated isoprenol and/or an alkoxylated hydroxybutyl vinyl ether and/or an alkoxylated vinyl ether and/or an alkoxylated (meth)allyl alcohol and/or a vinylated methyl polyalkylene glycol with preferably in each case an arithmetically average number of oxyalkylene groups of from 9 to 350. The comonomer component 1) should originate from the series of acrylic acid, methacrylic acid crotonic acid, isocrotonic acid, allylsulphonic acid, vinylsulphonic acid and suitable salts thereof and alkyl or hydroxyalkyl esters thereof, and/or the dicarboxylic acids, phosphonic acids and ethylenically unsaturated phosphoric acid esters.

The present invention furthermore provides that the representatives of component (a) have additional structural groups in copolymerized form. In this case, the additional structural groups can be styrenes, acrylamides and/or hydrophobic compounds, ester structural units, polypropylene oxide and polypropylene oxide/polyethylene oxide units being particularly preferred. The formulation claimed is indeed not limited to defined contents of the additional structural groups mentioned in the copolymer (a); nevertheless, it is advantageous according to the invention if the copolymer (a) contains the additional structural group in contents of up to 5 mol %, preferably from 0.05 to 3.0 mol % and in particular from 0.1 to 1.0 mol %.

With respect to the suitable representatives according to formula (I), it is to be noted that particular advantages are associated with an alternative in which these represent a polyether containing allyl or vinyl groups or an isoprenyl or methallyl compound.

Component (b):

Suitable representatives of the polycarboxylate esters (b) should preferably be a polymer which can be prepared by polymerization of a monomer mixture (I) containing as the main component a representative of the carboxylic acid monomer type. The monomer mixture (I) possible for this preferably contains an (alkoxy)polyalkylene glycol mono(meth)acrylic acid ester monomer b₁) of the general formula (II)

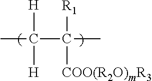

wherein R¹ represents a hydrogen atom or a CH₃ group, R²O represents a representative or a mixture of at least two oxyalkylene groups having 2 to 4 carbon atoms, R³ represents a hydrogen atom or an alkyl group having 1 to 5 carbon atoms and m represents a number between 1 and 350 and represents the average number of moles of the oxyalkylene group added,

additionally as monomer b2) a (meth)acrylic acid of the general formula (III),

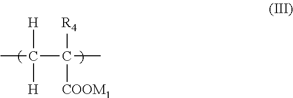

wherein R⁴ represents a hydrogen atom or a CH₃ group and M¹ represents a hydrogen atom, a monovalent metal atom, a divalent metal atom, an ammonium group or an organic amine group, and optionally a monomer b3), which can be copolymerized with the monomers b₁) and b₂).

Preferably, the monomer mixture (I) contains the monomer b₁) in an amount of from 5 to 98 wt %, the monomer b2) in an amount of from 2 to 95 wt. % and the monomer b₃) in an amount of up to 50 wt %, the particular amounts of the monomers b₁), b₂) and b₃) adding up to 100 wt %.

Preferred representatives of the monomer (a) in the context of the present invention can be: hydroxy-ethyl(meth)acrylate, hydroxy-propyl(meth)acrylate, polyethylene glycol mono(meth)acrylate, polypropylene glycol mono(meth)acrylate, polybutylene glycol mono(meth)acrylate, polyethylene glycol-polypropylene glycol mono(meth)acrylate, polyethylene glycol-polybutylene glycol mono(meth)acrylate, polypropylene glycol-polybutylene glycol mono(meth)acrylate, polyethylene glycol-polypropylene glycol-polybutylene glycol mono(meth)acrylate, methoxy-polyethylene glycol mono(meth)acrylate, methoxy polypropylene glycol mono(meth)acrylate, methoxy-polybutylene glycol mono(meth)acrylate, methoxy-polyethylene glycol-polypropylene glycol mono(meth)acrylate, methoxy-polyethylene glycol-polybutylene glycol mono(meth)acrylate, methoxy-polypropylene glycol-polybutylene glycol mono(meth)acrylate, methoxy-polyethylene glycol-polypropylene glycol-polybutylene glycol mono(meth)acrylate, ethoxy polyethylene glycol mono(meth)acrylate, ethoxy-polypropylene glycol mono(meth)acrylate, ethoxy-polybutylene glycol mono(meth)acrylate, ethoxy-polyethylene glycol-polypropylene glycol mono(meth)acrylate, ethoxy-polyethylene glycol-polybutylene glycol mono(meth)acrylate, ethoxy-polypropylene glycol-polybutylene glycol mono(meth)acrylate, ethoxy-polyethylene glycol-polypropylene glycol-polybutylene glycol mono(meth)acrylate or any desired mixtures thereof.

Monomer (b) can be a representative of the series of acrylic acid, methacrylic acid, (meth)allylsulphonic acid, HEMA phosphate, monovalent metal salts, divalent metal salts, ammonium salts and organic amine salts thereof and mixtures thereof.

Possible representatives of the monomer (c) are at least one representative of esters of an aliphatic alcohol having 1 to 20 carbon atoms with an unsaturated carboxylic acid, and in particular hydroxyethyl methacrylate (HEMA) or hydroxypropyl methacrylate (HPMA). The unsaturated carboxylic acid should preferably be maleic acid, fumaric acid, citraconic acid (meth)allylsulphonic acid, itaconic acid, (meth)acrylic acid or monovalent metal salts, divalent metal salts, ammonium salts or organic amine salts thereof. Monomers (c) can also be, however, monoesters or diesters of unsaturated carboxylic acids, such as maleic acid, fumaric acid or citraconic acid, with aliphatic C₁- to C₂₀-alcohols, C₂- to C₄-glycols or also with (alkoxy)polyalkylene glycol.

With respect to component (b), the present invention likewise provides for this to be a copolymer built up from at least one of the monomers present:
A) an ethylenically unsaturated monomer including a hydrolysable radical, wherein this hydrolysable monomer has an active bonding site;
B) an ethylenically unsaturated monomer with at least one C₂-C₄ oxyalkylene side group having a chain length of from 31 to 350 units.

Components A) and B) can also be represented simultaneously according to the invention as a copolymer in component (b).

According to the invention, the ethylenically unsaturated monomer of component A) can include at least one anhydride or imine and/or at least one maleic anhydride or maleimide. However, the ethylenically unsaturated monomer of component A) can also include a methacrylic acid ester or an acrylic acid ester in each case with an ester functionality which contains the hydrolysable radical. In this case, it is advisable for the ester functionality to be at least one hydroxypropyl or hydroxyethyl radical. It is furthermore to be regarded as preferable for the copolymer (b) to have more than one ethylenically unsaturated monomer with a hydrolysable radical in component A). In this case, the ethylenically unsaturated monomer of component A) can contain as the radical at least more than one representative of the ethylenically unsaturated monomers, at least one representative of a hydrolysable radical or a mixture of the two. It may also be advantageous for the hydrolysable radical in the cases mentioned last to contain at least one C₂-C₂ alcohol functionality. The hydrolysable radical can be a C₁-C₂₀-alkyl ester, a C₁-C₂₀-aminoalkyl ester, an amide or mixtures thereof.

With respect to component B) also, it is provided according to the invention that this can contain at least one ethylenically unsaturated monomer in the form of a C₂-C₈-alkyl ether group. Preferably, the ethylenically unsaturated monomer should contain a phenyl, allyl or (methyl)allyl ether or isoprenyl radical, or be derived from an unsaturated C₂-C₈-alcohol, which is preferably at least one representative of the series of phenyl alcohol, (meth)allyl alcohol, isoprenol or methylbutenol.

The present invention furthermore preferably provides that the ethylenically unsaturated monomer side groups of component B) contain at least one C₄-oxyalkylene unit and/or that at least one ethylenically unsaturated monomer of component B) contains a C₂-C₈-carboxylic acid ester, which in particular is hydrolysable.

The invention furthermore provides that the oxyalkylene side groups in component B) contain at least one ethylene oxide, one propylene oxide, one polyethylene oxide, one polypropylene oxide or mixtures thereof.

The copolymer (b) in component B) can also contain at least one nonionic and/or one non-hydrolysable monomer radical or mixtures thereof.

Component (c):

The present invention also provides several preferred alternatives with respect to the non-charged copolymer (c).

The non-charged copolymer (c), which is also to be described as a nonionic copolymer, can thus be a representative of the general formula (IV)

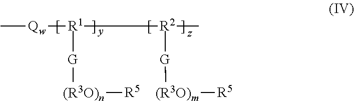

wherein Q represents an ethylenically unsaturated monomer with at least one hydrolysable radical, G denotes O, C(O)—O or O—(CH₂)ₚ—O, where p=2 to 8, mixtures of the variants of G being possible in one polymer; R¹ and R² independently of each other denote at least one C₂-C₈-alkyl; R³ includes (CH₂), wherein c is an integer between 2 and 5 and mixtures of the representatives of R³ in the same polymer molecule being possible; R⁵ denotes at least one representative chosen from the series of H, a linear or branched, saturated or unsaturated C₁-C₂₀ aliphatic hydrocarbon radical, a C₅-C₆ cycloaliphatic hydrocarbon radical or a substituted or unsubstituted CF₅—C₁₋₄ aryl radical; m=1 to 30, n=31 to 350, w=1 to 40, y=0 to 1 and z=0 to 1, where the sum (y+z) is >0.

The non-charged or nonionic copolymer c) can, however, also be represented by a representative of the general formula (V).

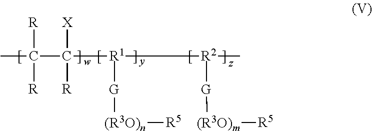

wherein X represents a hydrolysable radical and R represents H or CH₃; C, p, R¹, R², R³, R⁵, m, n, w, y, z and (y+z) have the meanings given under formula (IV). The hydrolysed radical mentioned can preferably be at least one representative chosen from the series of alkyl ester, hydroxyalkyl ester, aminohydroxyalkyl ester or amide.

In the context of the present invention, it is nevertheless also possible that the non-charged or nonionic copolymer (c) is at least one representative of the general formula (VI)

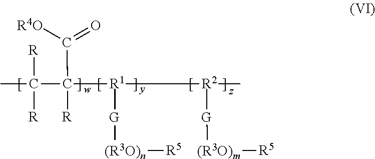

wherein R⁴ denotes at least one C₁-C₂₀ alkyl or C₂-C₂₀ hydroxyalkyl radical and the radicals G, p, R¹, R², R³, c, R⁴, R⁵ and m, n, w, y, z and (y+z) have the meanings given under formulae (IV) and (V).

Preferably, p=4 and R⁴═C₂H₄OH or C₃H₆OH; each of the radicals R⁵ represents H, m=5-30, n=31-250, w=1.5-30, y=0 to 1, z=0 to 1 and (y+z) is >0. The molar ratio of w to the sum (y+z) is 1:1 to 20:1 and is preferably 2:1 to 12:1.

It is to be regarded as preferable for the copolymer (c) to be a nonionic polyether/polyester copolymer.

The invention also provides that the dispersing agent claimed also comprises, in addition to the components (a), (b) and (c) thereof having a dispersing action, at least one additive chosen from the series of defoamer, surfactant, anticaking agent, pouring auxiliary, flameproofing agent, shrinkage reducing agent, retardant, accelerator, water retention agent, thickener. However, other substances are also additionally possible as additives, preferably as auxiliary substances and chosen from the series of extender, emulsifier, binder, dyestuff, biocide, stabilizer, antisettling agent, marking agent, release agent etc.

The total additives should amount to contents in the dispersing agent of a maximum of 10.0 wt. % and preferably from 0.05 to 5.0 wt. %.

Generally, it is to be regarded as advantageous if the defoamer is present in the free form; however, it can also be bonded by adsorption or chemically to at least one of the components (a), (b) and (c), it also being possible of course for the dispersing agent to comprise mixtures of these two forms,

Particularly suitable representatives of the surfactants are, for example, compounds chosen from the series of ethylene oxide/propylene oxide (EO/PO) block copolymer, styrene/maleic acid copolymer, fatty acid alcohol alkoxylate, alcohol ethoxylate R¹⁰-(EO)—H, where R₁₀=an aliphatic hydrocarbon group having 1 to 25 carbon atoms, acetylenic diol, monoalkyl polyalkylene, ethoxylated nonylphenol, alkyl sulphate, alkyl ether sulphate, alkyl ether sulphonate or alkyl ether carboxylate. However, component d) can also include an alcohol with a polyalkylene group, wherein the polyalkylene group has a carbon chain length of from 2 to 20 carbon atoms and preferably from 3 to 12 carbon atoms.

In addition to the dispersing agent, components (a), (b) and (c) thereof, the total composition and the particular contents of components, the present invention also claims a process for the preparation of the dispersing agent according to the invention in powder form.

In this context, components (a), optionally (b) and (c) are co-dried and in particular subjected to co-spray drying, in particular using at least one representative of anticaking agents, pouring auxiliaries and stabilizers. It has proved advantageous here to use a non-charged copolymer as component (c) which contains at least one monomer unit of which the side chains have an average molecular weight M_{w} of ≧1,000, preferably ≧2,000 and very particularly preferably ≧3,000.

For the process according to the invention, the use of acid units of which the total content of all charges in components (a), optionally (b) and (c) is a ≧5, preferably ≧7, very preferably ≧10% by weight.

Finally, the present invention also includes the use of a dispersing agent according to the invention for controlling the flowability of aqueous chemical construction suspensions, preferably based on inorganic binders and in particular hydraulic and/or latent hydraulic binders.

The binder should preferably be at least one representative chosen from the series of cements, in particular of the Portland cement classes CEM I, CEM II, GEM III, GEM IV, GEM V and the calcium aluminate cements, calcium sulphate-based compounds, preferably calcium sulphate hemihydrate, anhydrite or gypsum.

The dispersing agents according to the invention are suitable in particular for dry mortar compositions, and here in particular for tile adhesives, repair mortar, jointing mortar, bonding mortar, reinforcing mortar or plasters, but also alternatively in flowable and inorganic binders containing compositions, in particular in self-running stopper compositions or cast screeds.

The following examples illustrate the advantages of the invention.

### EXAMPLES

### 1. Preparation Examples

### Example 1.1

200 g of a 35 wt % strength aqueous solution of a dispersing agent which comprises as component having a dispersing action 100 wt % of the polycarboxylate ether Melflux PCE 2650 (component a1) were initially introduced into a glass beaker at room temperature.

1 g of a stabilizer intermediate comprising in each case 50 wt. % of a styrenized diphenylamine and 50 wt. % of a methyl polyethylene glycol of average molecular weight 500 g/mol was then added to the solution, which had a pH of 7, while stirring.

The emulsion obtained by this means was then converted into a powder in a laboratory spray dryer from NIRO-Atomizer (intake temperature 230° C., exit temperature 100° C.). The powder obtained was then treated with 2 g of silica in order to convert it into a pourable form.

After agglomerated particles had been sieved off through a 500 μm sieve, a white powder with an average particle diameter of 150 μm (air-jet sieve analysis) was obtained.

Finally, the powder was treated with 10 g of an anticaking agent to reduce the tendency to form lumps.

### Example 1.2

200 g of a 35 wt. % strength aqueous solution of a dispersing agent which comprises as component having a dispersing action 100 wt. % of the polycarboxylate ether VP 2661-599 (component a2) were initially introduced into a glass beaker at room temperature, 1 g of a stabilizer intermediate comprising in each case 50 wt % of a styrenized diphenylamine and 50 wt. % of a methyl polyethylene glycol of average molecular weight 500 g/mol was then added to the solution, which had a pH of 7, while stirring.

The emulsion obtained by this means was then converted into a powder in a laboratory spray dryer from NIRO-Atomizer (intake temperature 230° C., exit temperature 100° C.). The powder obtained was then treated with 2 g of silica in order to convert it into a pourable form.

After agglomerated particles had been sieved off through a 500 μm sieve, a white powder with an average particle diameter of 150 μm (air-jet sieve analysis) was obtained.

Finally, the powder was treated with 10 g of an anticaking agent to reduce the tendency to form lumps.

### Example 1.3

200 g of a 35 wt. % strength aqueous solution of a dispersing agent which comprises as component having a dispersing action 100 wt % of the polycarboxylate ester Melflux AP 100 L were initially introduced into a glass beaker at room temperature.

1 g of a stabilizer intermediate comprising in each case 50 wt % of a styrenized diphenylamine and 50 wt. % of a methyl polyethylene glycol of average molecular weight 500 g/mol was then added to the solution, which had a pH of 7, while stirring.

The emulsion obtained by this means was then converted into a powder in a laboratory spray dryer from MRO-Atomizer (intake temperature 230° C., exit temperature 100° C.). The powder obtained was then treated with 2 g of silica in order to convert it into a pourable form.

After agglomerated particles had been sieved off through a 500 μm sieve, a white powder with an average particle diameter of 150 μm (air-jet sieve analysis) was obtained.

Finally, the powder was treated with 10 g of an anticaking agent to reduce the tendency to form lumps.

### Example 1.4

200 g of a 35 wt. % strength aqueous solution of a dispersing agent which comprises as component having a dispersing action a combination of 50 wt. % of the polycarboxylate ether Melflux PCE 832 as representative of component (a), and 50 wt. % of an uncharged copolymer consisting of 10 mol % of a macromonomer (prepared by ethoxylated hydroxybutyl vinyl ether with 66 mol of EO) and 90 mol % of 2-hydroxyethyl acrylate as a representative of component (c) were initially introduced into a glass beaker at room temperature.

1 g of a stabilizer intermediate comprising in each case 50 wt. % of a styrenized diphenylamine and 50 wt. % of a methyl polyethylene glycol of average molecular weight 500 g/mol was then added to the solution, which had a pH of 7, while stirring.

The emulsion obtained by this means was then converted into a powder in a laboratory spray dryer from MRO-Atomizer (intake temperature 230° C., exit temperature 100° C.). The powder obtained was then treated with 2 g of silica in order to convert it into a pourable form.

After agglomerated particles had been sieved off through a 500 μm sieve, a white powder with an average particle diameter of 160 μm (air-jet sieve analysis) was obtained.

Finally, the powder was treated with 10 g of an anticaking agent to reduce the tendency to form lumps.

### Example 1.5

200 g of a 35 wt. % strength aqueous solution of a dispersing agent which comprises as component having a dispersing action a combination of 50 wt. % of the polycarboxylate ester Melflux AP 100 L 35% (component (b)), and 15 wt % of an uncharged copolymer consisting of 10 mol % of a macromonomer (prepared by ethoxylated hydroxybutyl vinyl ether with 66 mol of EO) and 90 mol % of 2-hydroxyethyl acrylate as a representative of component (c) were initially introduced into a glass beaker at room temperature.

1 g of a stabilizer intermediate comprising in each case 50 wt. % of a styrenized diphenylamine and 50 wt % of a methyl polyethylene glycol of average molecular weight 500 g/mol was then added to the solution, which had a pH of 7, while stirring.

The emulsion obtained by this means was then converted into a powder in a laboratory spray dryer from NIRO-Atomizer (intake temperature 230° C., exit temperature 100° C.). The powder obtained was then treated with 2 g of silica in order to convert it into a pourable form.

After agglomerated particles had been sieved off through a 500 μm sieve, a white powder with an average particle diameter of 150 μm (air-jet sieve analysis) was obtained.

Finally, the powder was treated with 10 g of an anticaking agent to reduce the tendency to form lumps.

### Example 1.6

200 g of a 35 wt. % strength aqueous solution of a dispersing agent which comprises as component having a dispersing action a combination of 15 wt. % of the polycarboxylate ether Melflux PCE 2670 (component a1), 28 wt. % of the polycarboxylate ether VP2661-599 (component a2), 42 wt. % of the polycarboxylate ester Melflux AP 100 L 35% (component (b)), and 15 wt. % of an uncharged copolymer consisting of 10 mol % of a macromonomer (prepared by ethoxylated hydroxybutyl vinyl ether with 66 mol of EO) and 90 mol % of 2-hydroxyethyl acrylate as a representative of component (c) were initially introduced into a glass beaker at room temperature.

1 g of a stabilizer intermediate comprising in each case 50 wt. % of a styrenized diphenylamine and 50 wt % of a methyl polyethylene glycol of average molecular weight 500 g/mol was then added to the solution, which had a pH of 7, while stirring.

The emulsion obtained by this means was then converted into a powder in a laboratory spray dryer from NIRO-Atomizer (intake temperature 230° C., exit temperature 100° C.). The powder obtained was then treated with 2 g of silica in order to convert it into a pourable form.

After agglomerated particles had been sieved off through a 500 μm sieve, a white powder with an average particle diameter of 150 μm (air-jet sieve analysis) was obtained.

Finally, the powder was treated with 10 g of an anticaking agent to reduce the tendency to form lumps.

### Example 1.7

200 g of a 35 wt. % strength aqueous solution of a dispersing agent which comprises as component having a dispersing action a combination of 42 wt. % of the polycarboxylate ether VP2661-599 (component a2), 42 wt. % of the polycarboxylate ester Melflux AP 100 L (component (b)), and 16 wt of an uncharged copolymer consisting of 10 mol % of a macromonomer (prepared by ethoxylated hydroxybutyl vinyl ether with 66 mol of EO) and 90 mol % of 2-hydroxybutyl acrylate as a representative of component (c) were initially introduced into a glass beaker at room temperature.

1 g of a stabilizer intermediate comprising in each case 50 wt % of a styrenized diphenylamine and 50 wt % of a methyl polyethylene glycol of average molecular weight 500 g/mol was then added to the solution, which had a pH of 7, while stirring.

The emulsion obtained by this means was then converted into a powder in a laboratory spray dryer from NIRO-Atomizer (intake temperature 230° C., exit temperature 100° C.). The powder obtained was then treated with 2 g of silica in order to convert it into a pourable form.

After agglomerated particles had been sieved off through a 500 μm sieve, a white powder with an average particle diameter of 150 μm (air jet sieve analysis) was obtained.

Filially, the powder was treated with 10 g of an anticaking agent to reduce the tendency to form lumps.

### Example 1.8

200 g of a 35 wt. % strength aqueous solution of a dispersing agent which comprises as component having a dispersing action a combination of 85 wt % of the polycarboxylate ether VP 2661-599 (component a2), and 15 wt. % of an uncharged copolymer consisting of 15 mol % of an uncharged macromonomer (prepared by ethoxylated hydroxybutyl vinyl ether with 66 mol of EO) and 85 mol % of 2-hydroxyethyl acrylate as a representative of component (c) were initially introduced into a glass beaker at room temperature.

1 g of a stabilizer intermediate comprising in each case 50 wt. % of a styrenized diphenylamine and 50 wt. % of a methyl polyethylene glycol of average molecular weight 500 g/mol was then added to the solution, which had a pH of 7, while stirring.

The emulsion obtained by this means was then converted into a powder in a laboratory spray dryer from NIRO-Atomizer (intake temperature 230° C., exit temperature 100° C.). The powder obtained was then treated with 2 g of silica in order to convert it into a pourable form.

After agglomerated particles had been sieved off through a 500 μm sieve, a white powder with an average particle diameter of 150 μm (air-jet sieve analysis) was obtained.

Filially, the powder was treated with 10 g of an anticaking agent to reduce the tendency to form lumps.

### Example 1.9

200 g of a 35 wt. % strength aqueous solution of a dispersing agent which comprises as component having a dispersing action a combination of 75 wt. % of the polycarboxylate ether Melflux PCE 598 as representative of component (a), and 25 wt % of an uncharged copolymer consisting of 5 mol % of a macromonomer (prepared by ethoxylated hydroxybutyl vinyl ether with 66 mol of EO) and 95 mol % of 2-hydroxyethyl acrylate as a representative of component (c) were initially introduced into a glass beaker at room temperature.

1 g of a stabilizer intermediate comprising in each case 50 wt. % of a styrenized diphenylamine and 50 wt % of a methyl polyethylene glycol of average molecular weight 500 g/mol was then added to the solution, which had a pH of 7, while stirring.

The emulsion obtained by this means was then converted into a powder in a laboratory spray dryer from NIRO-Atomizer (intake temperature 230° C., exit temperature 100° C.). The powder obtained was then treated with 2 g of silica in order to convert it into a pourable form.

After agglomerated particles had been sieved off through a 500 μm sieve, a white powder with an average particle diameter of 130 μm (air-jet sieve analysis) was obtained.

Finally, the powder was treated with 10 g of an anticaking agent to reduce the tendency to form lumps.

### Example 1.10

200 g of a 35 wt. % strength aqueous solution of a dispersing agent which comprises as component having a dispersing action a combination of 5 wt % of the polycarboxylate ether Melflux PCE 2670, as a representative of component (a), 45 wt. % of the drying assistant Melflux AP 4547/232, as a representative of component (d), and 50 wt. % of an uncharged copolymer consisting of 10 mol % of a macromonomer (prepared by ethoxylated hydroxybutyl vinyl ether with 130 mol of EO) and 90 mol % of 2-hydroxyethyl acrylate as a representative of component (c) were initially introduced into a glass beaker at room temperature.

1 g of a stabilizer intermediate comprising in each case 50 wt. % of a styrenized diphenylamine and 50 wt. % of a methyl polyethylene glycol of average molecular weight 500 g/mol was then added to the solution, which had a pH of 7, while stirring.

The emulsion obtained by this means was then converted into a powder in a laboratory spray dryer from NIRO-Atomizer (intake temperature 230° C., exit temperature 100° C.). The powder obtained was then treated with 2 g of silica in order to convert it into a pourable form.

After agglomerated particles had been sieved off through a 500 μm sieve, a white powder with an average particle diameter of 120 μm (air-jet sieve analysis) was obtained.

Finally, the powder was treated with 10 g of an anticaking agent to reduce the tendency to form lumps.

### 2. Use Example

Recipe

1,350 g of CEM 142.5 R

1,350 g of CEN standard sand

0.675 g of pulverulent defoamer (Agitan P800)

x g of dispersing agent

432.17 g of water (15%)

Mixing Instructions:

The fresh mortar is prepared in accordance with DIN EN 196-1 section 6.3, but at 35° C. The flow time in accordance with DIN EN 445 was then determined,

Test Method 1

| | Dispersing agent | | | | | | | |
|---|---|---|---|---|---|---|---|---|
| | in accordance with | | Weight | Flow time [s] | | | | Difference |
| Mortar | preparation example | | g | 5 min | 10 min | 20 min | 30 min | 30-5 min |
| 1 | 1.1 | Comp. a1 | 1.00 | 98 | * | * | * | * |
| 2 | 1.2 | Comp. a2 | 1.00 | 71 | 129 | 287 | * | * |
| 3 | 1.3 | Comp. b | 1.00 | 73 | 93 | 107 | 137 | 64 |
| 4 | 1.4 | Comp. a2 + c | 1.25 | * | * | 120 | 108 | * |
| 5 | 1.5 | Comp. b + c | 1.25 | 79 | 95 | 108 | 124 | 45 |
| 6 | 1.6 | Comp. a2 + b + c | 1.25 | 68 | 91 | 95 | 99 | 31 |

* Cannot be tested since the mortar blocks the flow funnel and does not flow out completely or calculation is not possible.

Test Method 2: Sump EN 1015-3

| | Dispersing agent in | | | | | | | |
|---|---|---|---|---|---|---|---|---|
| | accordance with | | Weight | Slump [mm] | | | | Difference |
| Mortar | preparation example | | g | 5 min | 10 min | 20 min | 30 min | 30-5 min |
| 1 | 1.1 | Comp. a1 | 1.00 | 220 | 189 | 120 | 100 | −120 |
| 2 | 1.2 | Comp. a2 | 1.00 | 256 | 217 | 195 | 165 | −91 |
| 3 | 1.3 | Comp. b | 1.00 | 285 | 269 | 255 | 235 | −50 |
| 4 | 1.4 | Comp. a2 + c | 1.25 | 187 | 178 | 254 | 284 | 97 |
| 5 | 1.5 | Comp. b + c | 1.25 | 233 | 232 | 264 | 283 | 50 |
| 6 | 1.6 | Comp. a2 + b + c | 1.25 | 288 | 274 | 264 | 261 | −27 |

Of all the mixtures, mixture 6 keeps the consistency the longest. No post-liquefaction occurs.

1-53. (canceled)

54. A dispersing agent comprising:
(a) a polycarboxylate ether with a weight content of from 0.1 to 20%;
(b) a polycarboxylate ester with a weight content of from 0 to 20%; and
(c) a non-charged copolymer with a weight content of from 0.1 to 20%.

55. A dispersing agent according to claim 54, in powder form.

56. A dispersing agent according to claim 55, prepared by the process comprising the step of co-drying components (a) and (b).

57. A dispersing agent according to claim 55, wherein component (a) has been subjected to a drying process.

58. A dispersing agent according to claim 54, wherein the polycarboxylate ether (a) comprises two representatives of a copolymer which differ from one another, each comprising
1) at least one olefinically unsaturated carboxylic acid derivative, an ester of an olefinically unsaturated carboxylic acid derivative, a salt of an olefinically unsaturated carboxylic acid derivative, an olefinically unsaturated sulphonic acid derivative or a salt of an olefinically unsaturated sulphonic acid derivative; and
2) at least one comonomer which, by the reaction of the polyether macromonomer, produces a structural unit in the copolymer which is represented by one of the general formulae (Ia), (Ib) or (Ic): 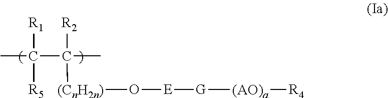
wherein
R¹, R² and R³ are in each case identical or different and independently of each other are represented by H or an unbranched or branched C₁-C₄ alkyl group;
E is identical or different and is represented by an unbranched or branched C: —C₆ alkylene group, a cyclohexyl group, CH₂—C₆H₁₀, ortho-meta- or para.-substituted C₆H₄ or a unit which is not present;
G is identical or different and is represented by O, NH or CO NH, with the proviso that if E is a unit which is not present, G is also in the form of a unit which is not present;
A is identical or different and is represented by CₓH₂ₓ, wherein x is 2, 3, 4 or 5 or CH₂CH(C₆H₅);
n is identical or different and is 0, 1, 2, 3, 4 or 5;
a is identical or different and is represented by an integer from 7 to 350 (preferably 10-200);
R⁴ is identical or different and is represented by H, an unbranched or branched C₁-C₂₀ alkyl group, a cycloaliphatic hydrocarbon radical having 5 to 8 C atoms, an optionally substituted aryl radical having 6 to 14 C atoms, CO—NH₂ or COCH₃; 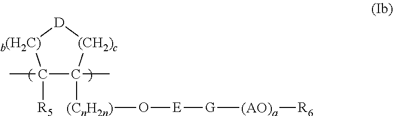
wherein
R⁵ is identical or different and is represented by H or an unbranched or branched C₁-C₄ alkyl group;
E is identical or different and is represented by an unbranched or branched C₁-C₆ alkylene group, a cyclohexyl group, CH₂—C₆H₁₀, ortho-meta- or para-substituted C₆H₄;
G is identical or different and is represented by a unit which is not present, O, NH or CO—NH, with the proviso that if E is a unit which is not present, G is also in the form of a unit which is not present;
A is identical or different and is represented by CₓH₂ₓ, where x is 2, 3, 4 or 5 or CH₂CH(C₆H₅);
n is identical or different and is represented by 0, 1, 2, 3, 4 or 5;
a is identical or different and is represented by an integer from 7 to 350;
D is identical or different and is represented by a unit which is not present, NH or O, with the proviso that if D is a unit which is not present: b is 0, 1, 2, 3 or 4 and c is 0, 1, 2, 3 or 4, where b+c is 3 or 4, and
with the proviso that if D is NH or O: b is 0, 1, 2 or 3, c is 0, 1, 2 or 3, where b+c is 2 or 3;
R⁶ is identical or different and is represented by H, an unbranched or branched C₁-C₂₀ alkyl group, a cycloaliphatic hydrocarbon radical having 5 to 8 C atoms, an optionally substituted aryl radical having 6 to 14 C atoms, CO—NH₂ or COCH₃; 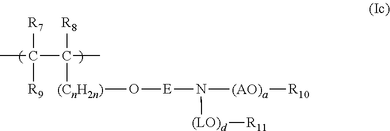
wherein
R⁷, R⁸ and R⁹ are in each case identical or different and independently of each other are represented by H or an branched or branched C₁-C₄ alkyl group;
E is identical or different and is represented by an unbranched or branched C₁-C₆ alkylene group, a cyclohexyl group, CH₂—C₆H₁₀, ortho-meta- or para-substituted C₆—H₄ or by a unit which is not present;
A is identical or different and is represented by CₓH₂ₓ, where x is 2, 3, 4 or 5 or CH₂CH(C₆H₅);
n is identical or different and is represented by 0, 1, 2, 3, 4 or 5;
L is identical or different and is represented by CₓH₂ₓ, where x is 2, 3, 4 or 5 or C₁₂—CH(C₆H₅);
a is identical or different and is represented by an integer from 7 to 350;
d is identical or different and is represented by an integer from 2 to 350;
R¹⁰ is identical or different and is represented by H or an unbranched or branched C₁-C₄ alkyl group;
R¹¹ is identical or different and is represented by H or an unbranched C₁-C₄ alkyl group.
wherein 1.) in the copolymer a) the units which represent components 1) or 2) in each case have no differences within the molecule, or 2.) the copolymer a) is a polymeric mixture of components 1) and 2), wherein in this case the units have differences within the molecule with respect to the radicals R₁ or R₂ or R₃ or R₄ or R₅ or R₆ or R₇ or R₈ or R₉ or R₁₀ or R₁₁ or n or a or b or c or d, and wherein the differences referred to relate in particular to the composition and length of the side chains.

59. A dispersing agent according to claim 54, wherein the copolymer (a) contains the comonomer component 1) in contents of from 50 to 90 mol % and the comonomer component 2) in contents of from 50 to 1 mol %.

60. A dispersing agent according to claim 58, wherein the copolymer (a) contains the comonomer component 1) in contents of from 60 to 90 mol % and the comonomer component 2) in contents of from 40 to 10 mol %.

61. A dispersing agent according to claim 58, wherein the comonomer component 1) represents an acrylic acid or a salt thereof, and the comonomer component 2) contains as the polyether macromonomer an alkoxylated isoprenol or an alkoxylated hydroxybutyl vinyl ether or an alkoxylated vinyl ether or an alkoxylated (meth)allyl alcohol or a vinylated methyl polyalkylene glycol with preferably in each case an arithmetically average number of oxyalkylene groups of from 9 to 350.

62. A dispersing agent according to claim 58, wherein the comonomer component 1) originates from the series of acrylic acid, methacrylic acid crotonic acid, isocrotonic acid, allylsulphonic acid, vinylsulphonic acid and suitable salts thereof and alkyl or hydroxyalkyl esters thereof, or the dicarboxylic acids, phosphonic acids and ethylenically unsaturated phosphoric acid esters.

63. A dispersing agent according to claim 58, wherein the copolymer (a) contains additional structural groups in copolymerized form.

64. A dispersing agent according to claim 63, wherein the additional structural groups are styrenes, acrylamides, ester structural units, polypropylene oxide and polypropylene oxide/polyethylene oxide.

65. A dispersing agent according to claim 63, wherein the copolymer (a) contains the additional structural group in contents of up to 5 mol %, preferably from 0.05 to 3.0 mol % and in particular from 0.1 to 1.0 mol %.

66. A dispersing agent according to claim 58, wherein the formula (I) represents a polyether containing allyl or vinyl groups or an isoprenyl or methallyl compound.

67. A dispersing agent according to claim 54, wherein the representative of the polycarboxylate esters (b) is a polymer which can be prepared by polymerization of a monomer mixture (I) containing as the main component a representative of the carboxylic acid monomer type.

68. A dispersing agent according to claim 67, wherein the monomer mixture (I) contains an (alkoxy)polyalkylene glycol mono(meth)acrylic acid ester monomer b₁) of formula (II) 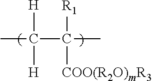
wherein R¹ represents a hydrogen atom or a CH₃ group, R²O represents a representative or a mixture of at least two oxyalkylene groups having 2 to 4 carbon atoms, R³ represents a hydrogen atom or an alkyl group having 1 to 5 carbon atoms and m represents a number between 1 and 350 and represents the average number of moles of the oxyalkylene group added,
additionally as monomer b₂) a (meth)acrylic acid of formula (III), 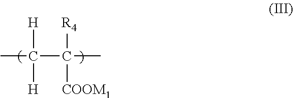
wherein R⁴ represents a hydrogen atom or a CH₃ group and M¹ represents a hydrogen atom, a monovalent metal atom, a divalent metal atom, an ammonium group or an organic amine group,
and optionally a monomer b₃), which can be copolymerized with the monomers b₁) and b₇).

69. A dispersing agent according to claim 68, wherein the monomer mixture (I) contains the monomer b₁) in an amount of from 5 to 98 wt. %, the monomer b₂) in an amount of from 2 to 95 wt % and the monomer b₃) in an amount of up to 50 wt %, the particular amounts of the monomers b₁), b₂) and b₃) adding up to 100 wt %.

70. A dispersing agent according to claim 58, wherein the monomer b0 comprises at least one member selected from the group consisting of hydroxyethyl(meth)acrylate, hydroxypropyl(meth)acrylate, polyethylene glycol mono(meth)acrylate, polypropylene glycol mono(meth)acrylate, polybutylene glycol mono(meth)acrylate, polyethylene glycol-polypropylene glycol mono(meth)acrylate, polyethylene glycol-polybutylene glycol mono(meth)acrylate, polypropylene glycol-polybutylene glycol mono(meth)acrylate, polyethylene glycol-polypropylene glycol-polybutylene glycol mono(meth)acrylate, methoxy-polyethylene glycol mono(meth)acrylate, methoxy-polypropylene glycol mono(meth)acrylate, methoxy-polybutylene glycol mono(meth)acrylate, methoxy-polyethylene glycol-polypropylene glycol mono(meth)acrylate, methoxy-polyethylene glycol-polybutylene glycol mono(meth)acrylate, methoxy-polypropylene glycol-polybutylene glycol mono(meth)acrylate, methoxy-polyethylene glycol-polypropylene glycol-polybutylene glycol mono(meth)acrylate, ethoxy-polyethylene glycol mono(meth)acrylate, ethoxy-polypropylene glycol mono(meth)acrylate, ethoxy-polybutylene glycol mono(meth)acrylate, ethoxy-polyethylene glycol-polypropylene glycol mono(meth)acrylate, ethoxy-polyethylene glycol-polybutylene glycol mono(meth)acrylate, ethoxy-polypropylene glycol-polybutylene glycol mono(meth)acrylate and ethoxy-polyethylene glycol-polypropylene glycol-polybutylene glycol mono(meth)acrylate.

71. A dispersing agent according to claim 68, wherein the monomer b₂) is a representative of the series of acrylic acid, methacrylic acid, (meth)allylsulphonic acid, HEMA phosphate, monovalent metal salts, divalent metal salts, ammonium salts and organic amine salts thereof and mixtures thereof.

72. A dispersing agent according to claim 68, wherein the monomer b₃) is at least one representative of esters of an aliphatic alcohol having 1 to 20 carbon atoms with an unsaturated carboxylic acid, and in particular hydroxyethyl methacrylate (HEMA) or hydroxypropyl methacrylate (HPMA).

73. A dispersing agent according to claim 72, wherein the unsaturated carboxylic acid is maleic acid, fumaric acid, citraconic acid (meth)allylsulphonic acid, itaconic acid, (meth)acrylic acid or monovalent metal salts, divalent metal salts, ammonium salts or organic amine salts thereof.

74. A dispersing agent according to claim 72, wherein it is monoesters or diesters of unsaturated carboxylic acids, such as maleic acid, fumaric acid or citraconic acid, with aliphatic C₁-C₂₀-alcohols, C₂-C₄-glycols or with (alkoxy)polyalkylene glycols.

75. A dispersing agent according to claim 54, wherein component (b) is a copolymer built up from at least one of the following monomers:
A) an ethylenically unsaturated monomer including a hydrolysable radical, wherein this hydrolysable monomer has an active bonding site;
B) an ethylenically unsaturated monomer with at least one C₂-C₄ oxyalkylene side group having a chain length of from 1 to 350 units.

76. A dispersing agent according to claim 75, wherein components A) and B) are represented in the copolymer (b).

77. A dispersing agent according to claim 75, wherein the ethylenically unsaturated monomer of component A) includes at least one anhydride or imide or at least one maleic anhydride or maleimide.

78. A dispersing agent according to claim 75, wherein the ethylenically unsaturated monomer of component A) includes a (meth)acrylic acid ester with an ester functionality which contains the hydrolysable radical.

79. A dispersing agent according to claim 78, wherein the ester functionality is at least one hydroxypropyl or hydroxyethyl.

80. A dispersing agent according to claim 75, wherein the copolymer b) contains more than one ethylenically unsaturated monomer with a hydrolysable radical in component A).

81. A dispersing agent according to claim 80, wherein the ethylenically unsaturated monomer of component A) contains as the radical at least more than one representative of the ethylenically unsaturated monomers, at least one representative of a hydrolysable radical or a mixture of the two.

82. A dispersing agent according to claim 80, wherein the hydrolysable radical contains at least one C₂-C₂₀-alcohol functionality.

83. A dispersing agent according to claim 78, wherein the hydrolysable radical is selected from the group consisting of a C₁-C₂₀-alkyl ester, a C₁-C₂₀-aminoalkyl ester, a C₂-C₂₀-alcohol, a C₂-C₂₀-amino alcohol and an amide.

84. A dispersing agent according to claim 75, wherein at least one ethylenically unsaturated monomer of component B) contains a C₂-C₈-alkyl ether group.

85. A dispersing agent according to claim 84, wherein the ethylenically unsaturated monomer contains a vinyl radical, an allyl radical, a (methyl)allyl ether radical, an isoprenyl radical, or is derived from an unsaturated C₂-C₈-alcohol.

86. A dispersing agent according to claim 85, wherein the unsaturated C₂-C₈-alcohol is selected from the group consisting of vinyl alcohol, (meth)allyl alcohol, isoprenol or methylbutenol.

87. A dispersing agent according to claim 75, wherein the ethylenically unsaturated monomer side groups of component B) contain at least one C₄-oxyalkylene unit.

88. A dispersing agent according to claim 75, wherein at least one ethylenically unsaturated monomer of component B) contains a C₂-C₈-carboxylic acid ester, which in particular is hydrolysable.

89. A dispersing agent according to claim 75, wherein the oxyalkylene side groups contain at least one ethylene oxide, one propylene oxide, one polyethylene oxide, one polypropylene oxide or mixtures thereof.

90. A dispersing agent according to claim 75, wherein the copolymer h) in component B) contains at least one nonionic or one non-hydrolysable monomer radical or mixtures thereof.

91. A dispersing agent according to claim 54, wherein the non-charged copolymer (c) is of formula (IV) 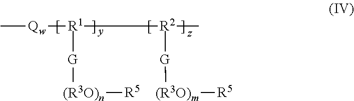
wherein Q represents an ethylenically unsaturated monomer with at least one hydrolysable radical, G denotes O, C(O)—O or O—(CH₂)ₚ—O, where p=2 to 8, mixtures of the variants of G being possible in one polymer; R¹ and R² independently of each other denote at least one C₂-C₈-alkyl; R³ includes (CH₂)_{c}, wherein c is an integer between 2 and 5 and mixtures of the representatives of R³ in the same polymer molecule being possible; R⁵ denotes at least one representative chosen from the series of H, a linear or branched, saturated or unsaturated C₁-C₂₀ aliphatic hydrocarbon radical, a C₅-C₈ cycloaliphatic hydrocarbon radical or a substituted or unsubstituted C₆-C₁₄ aryl radical; m=1 to 30, n=31 to 350, w=1 to 40, y=0 to 1 and z=0 to 1, wherein the sum (y z) is >0.

92. A dispersing agent according to claim 54, wherein the non-charged copolymer (c) is a representative of the general formula (V) 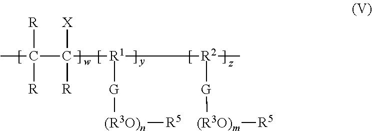
wherein X represents a hydrolysable radical and R represents H air CH₃; G, p, R¹, R², R³, R⁵, m, n, w, y, z and (y+z) have the meanings given under formula (IV).

93. A dispersing agent according to claim 92, wherein the hydrolysable radical is at least one representative from the series of alkyl ester, aminoallyl ester, hydroxyalkyl ester, aminohydroxyalkyl ester or amide.

94. A dispersing agent according to claims 54 to 90, wherein the non-charged copolymer (c) is at least one representative of formula (VI) 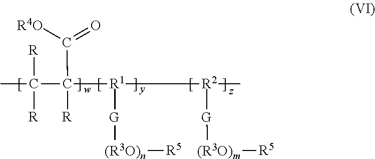
wherein R⁴ denotes at least one (C₁-C₂₀ alkyl or C₂-C₂₀ hydroxyalkyl radical and the radicals G, p, R, R¹, R², R³, c, R⁴, R⁵ and m, n, w, y, z and (y+z) have the meanings given under formulae (IV) and (V).

95. A dispersing agent according to claim 41, wherein p is 4, R⁴ denotes C₂H₄OH or C₃H₆OH, each of the radicals R⁵ is H, m is from 5 to 30, n is from 31 to 250, w is from 1.5-30, y is from 0 to 1, z is form 0 to 1 and (y+z) is >0.

96. A dispersing agent according to claim 38, wherein the molar ratio of w to the sum (y+z) is 1:1 to 20:1.

97. A dispersing agent according to claim 54, wherein the copolymer (c) is a nonionic polyether/polyester copolymer.

98. A dispersing agent according to claim 54, wherein, in addition to the components (a), (b) and (c) having a dispersing action, it comprises at least one additive chosen from the series of defoamer, surfactant, anticaking agent, pouring auxiliary, flameproofing agent, shrinkage reducing agent, retardant, accelerator, water retention agent, thickener.

99. A dispersing agent according to claim 98, wherein it comprises the total additives in contents up to a maximum of 10.0 wt. %.

100. A process for the preparation of the pulverulent dispersing agent according to claim 54 comprising spray drying co-drying components (a), optionally (b) and (c).

101. A process according to claim 100, wherein a non-charged copolymer (c) which contains at least one monomer unit of which the side chains have an average molecular weight M_{w} of ≧1,000.

102. A process according to claim 100, wherein acid units of which the total content of all charges in components (a), optionally (b) and (c) is ≧5.

103. A method of controlling the flowability of aqueous chemical construction suspensions based on inorganic binders and in particular hydraulic or latent hydraulic, binders comprising adding the dispersing agent of claim 54 to the aqueous construction suspensions in an amount sufficient to control the flowability thereof.

104. A method according to claim 103, wherein the binder is at least one representative chosen from the series of cements, preferably of the Portland cement classes CEM I, CEM II, CEM III, CEM IV, CEM V and the calcium aluminate cements, calcium sulphate-based compounds, preferably calcium sulphate hemihydrate, anhydrite or gypsum.

105. A method according to claim 103 in dry mortar compositions, preferably in a tile adhesive, repair mortar, jointing mortar, bonding mortar, reinforcing mortar or plaster.

106. A method according to claim 103 in flowable and inorganic binder-containing compositions, in particular in self-running stopper compositions or cast screeds.

107. The dispersant of claim 55, wherein the powder is water soluble.
